(19) United States
(12) Patent Application Publication
(10) Pub. No.: US 2013/0183423 A1
(43) Pub. Date: Jul. 18, 2013

(54) Food Storage and Dispensing System

(71) Applicant: AdvancePierre Foods, Inc., Cincinnati, OH (US)

(72) Inventors: Nancy Riess Todys, Milford, OH (US); Joyce Astrik Keoleian, Liberty Township, OH (US); Grant Bingham Wilson, Edmond, OK (US); Anthony Joseph Schroder, Guilford, IN (US)

(73) Assignee: ADVANCEPIERRE FOODS, INC., Cincinnati, OH (US)

(21) Appl. No.: 13/728,459

(22) Filed: Dec. 27, 2012

Related U.S. Application Data
(60) Provisional application No. 61/580,873, filed on Dec. 28, 2011.

(51) Int. Cl. A47J 39/00

(52) U.S. Cl. CPC A47J 39/00
USPC 426/418; 99/483

(57) ABSTRACT

A food storage and dispensing device including a body having a generally closed inner cavity and a door configured to provide access to the inner cavity. The device further includes a support surface positioned in the inner cavity, the support surface having at least one opening. The device also includes a heat source positioned below the support surface, wherein the opening is shaped to closely receive a tray therein to thereby trap heat below said support surface.

This application claims priority to U.S. Provisional Patent Application Ser. No. 61/580,873, the entire contents of which are incorporated by reference herein.

The present invention is directed to a system for storing and dispensing food items, such as food patties.

### BACKGROUND

Convenience stores, concession stands, fuel refilling stations and the like may offer hot food to their customers. However, such establishments typically have only limited options for providing hot, fresh sandwiches that are made to order. For example, in one case establishments may utilize a staffed hot sandwich counter. However, such a counter requires dedicated store personnel who must handle food during the preparation of the product. Therefore such counters typically require a food handling permit and the use of additional equipment such as sinks, preparation stations, etc. to comply with the relevant codes and regulations.

Establishments may also utilize roller grills, in which cylindrical food items, such as hot dogs, are turned over rotating rollers while heat is applied. Such roller grills enable customers to create their own sandwich in a self-serve format, and do not typically require a food handling permit or additional food preparation or cleaning equipment. However, roller grills are limited in that they generally require the food product to be generally cylindrical so that the food product can properly roll on the roller grill.

Finally, establishments may use a sandwich warmer cabinet, which allows the establishment to prepare or purchase and display pre-assembled, pre-packaged hot sandwiches for direct access by the customer. However, this arrangement can typically only be used with pre-assembled, prepackaged sandwiches. Moreover, if a customer wishes to customize their sandwich, such as by adding condiments, toppings etc., the customer must first unwrap the sandwich and at least partially disassemble the sandwich. This process is inconvenient and often messy.

### SUMMARY

In one embodiment the present invention is a system for providing sandwich and patty food options to a customer in a manner that does not require the use of a food handling permit, does not require food preparation and cleaning stations, can be used with food products of varying shapes and sizes, and enables the customer to customize the sandwich as desired. More particularly, in one embodiment the invention is a food storage and dispensing device including a body having a generally closed inner cavity and a door configured to provide access to the inner cavity. The device further includes a support surface positioned in the inner cavity, the support surface having at least one opening. The device also includes a heat source positioned below the support surface, wherein the opening is shaped to closely receive a tray therein to thereby trap heat below said support surface.

### BRIEF DESCRIPTION OF DRAWINGS

FIG. 1 is a front perspective view of one embodiment of a storage and dispensing system;

FIG. 2 is a front cross section of the upper part of the system of FIG. 1, taken along line 2-2 of FIG. 1;

FIG. 3 is a front perspective view of a user preparing a food storage tray for use in the storage and dispensing system of FIG. 1;

FIG. 4 is a front perspective view of the storage and dispensing system of FIG. 1 in an alternate configuration; and

FIG. 5 is a front perspective view of the storage and dispensing system of FIG. 1 in another alternate configuration, with the support tray in an exploded configuration.

### DETAILED DESCRIPTION

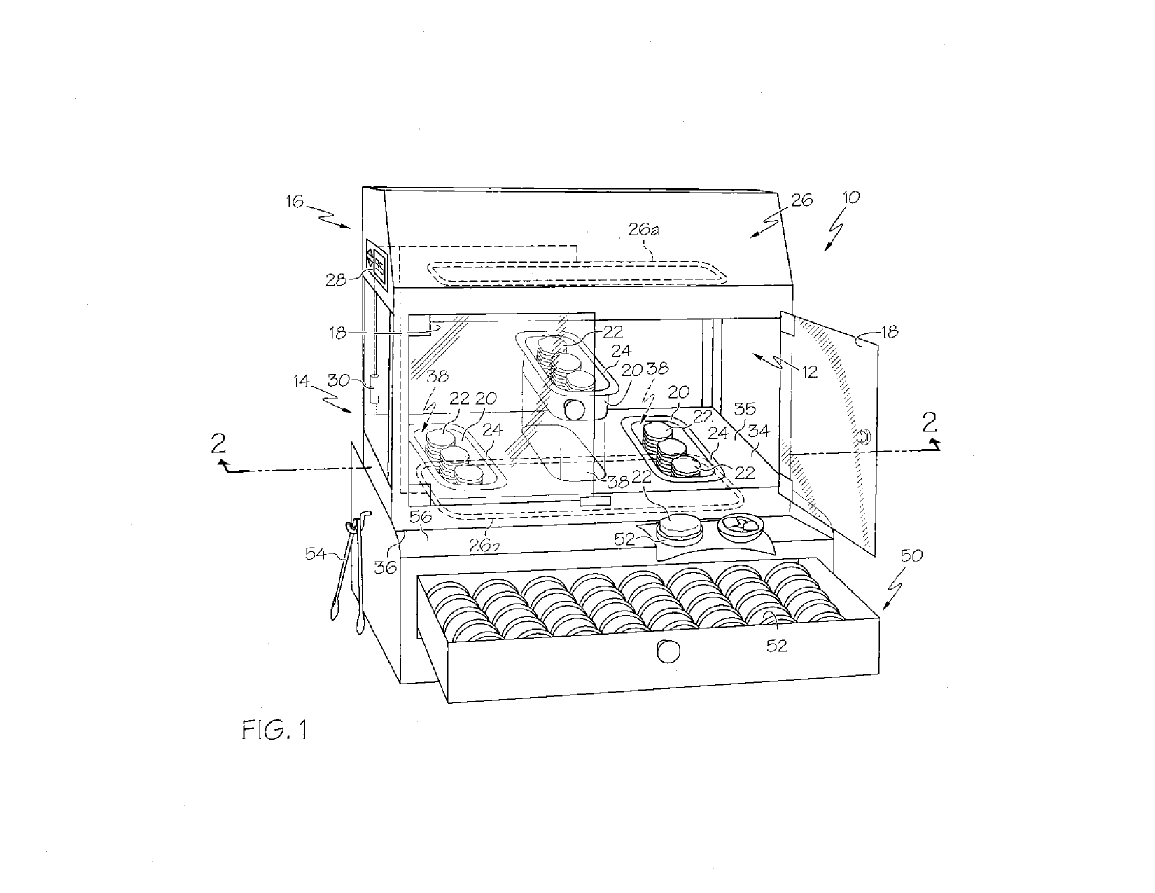

As shown in FIGS. 1, 2, 4 and 5, in one embodiment the invention utilizes or takes the form of a storage cabinet, generally designated 10, which can store various food products therein. In particular, in the illustrated embodiment the storage cabinet 10 includes a frame or body and is shaped as a generally rectangular prism having an inner cavity 12 therein. The storage cabinet 10 includes a lower portion 14 made primarily of generally clear, transparent or translucent material such as tempered glass, Plexiglass, etc. The storage cabinet 10 includes an upper portion 16 positioned above the lower portion 14, and is, in the illustrated embodiment, made of an opaque material, such as metal, plastic, polymers, etc.

The storage cabinet 10, and in particular the lower portion 14, includes a pair of hinged doors 18 which can also be generally clear, transparent or translucent. The doors 18 can be moved to an open position to provide full access to the inner cavity 12, and to a closed positioned to generally seal the inner cavity 12 and help trap heat and aromas. The transparent/translucent nature of the lower portion 14 allows customers to view and inspect the food product stored in the storage cabinet 10 from various angles and directions, and also aids in attracting the attention of potential customers.

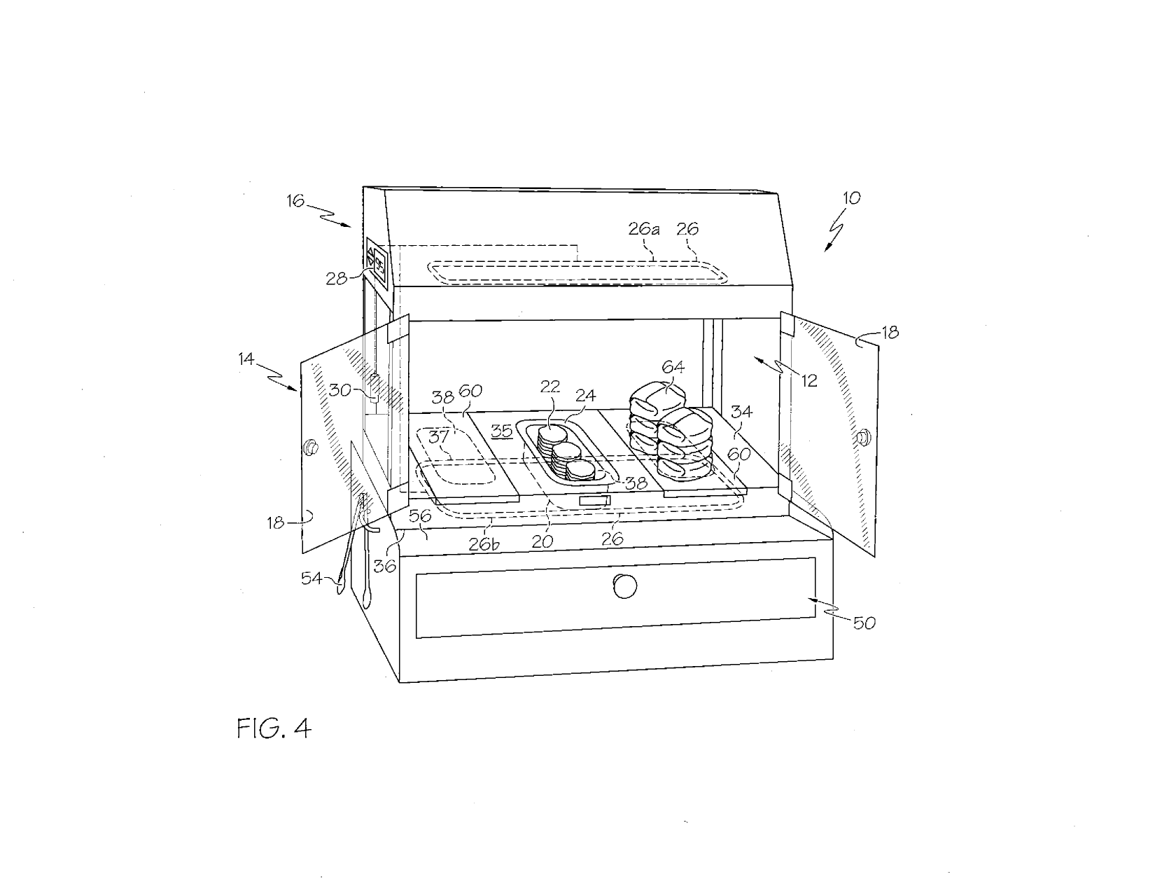

The storage cabinet 10 may store or receive a plurality of food storage trays 20 therein. Each tray 20 is, in the illustrated embodiment, a generally rectangular prism storing a plurality of food products 22 therein. Each tray 20 may include an outwardly protruding lip 24 extending around the upper perimeter thereof. In the illustrated embodiment, the food product 22 takes the form of patty products or other protein products without any buns, bread or the like. In particular, FIGS. 1 and 4 illustrate each tray 20 having three stacks of patties 22, each stack including a plurality of patties 22 arranged in a cylindrical pattern, with the stacks being arranged in a straight-line pattern in the tray 20. However the number and arrangement of patties 22 in a tray 20 can be varied as desired. For example, in one case the tray 20 has three stacks of patties 22 arranged in a staggered or zig-zag pattern, as opposed to the straight-line pattern shown in FIGS. 1 and 4, which provides a more compact arrangement in the lengthwise direction. In addition, it should be understood that the system described herein is not necessarily limited to use with patty-style food products, but can be used with a wide variety of other products of varying shapes and configurations.

The storage cabinet 10 may include a heat source 26 therein to maintain the food product 22 at a predetermined temperature or within a temperature range. In the illustrated embodiment, the heat source 26 takes the form of heating elements 26a, 26b positioned near the top and bottom of the storage cabinet 10, respectively with the food product 22 positioned vertically therebetween. This arrangement of heating elements 26a, 26b provides even heating, and minimizes the drying effect of the heat upon the food product 22. It has been found that applying heat only from the top of the storage cabinet 10 can cause the food product 22 to dry out. More particularly, in that case the top-most patties 22 in a tray 20 may be prone to drying out since their top surfaces are exposed. Providing heat from the bottom heating element 26b provides more direct heat to the middle and bottom patties, which are generally sealed by patties on the top and/or bottom, can help retain moisture in the patties 22.

The storage cabinet 10 may include a thermostat/controller 28 operatively coupled to the heat source 26 so that the inner cavity 12 can be maintained at a pre-set temperature, or within a pre-determined range, or above a predetermined temperature. In some cases the food product 22 is desired to be maintained at a particular temperature as set by local health codes, and the use of thermostat 28 helps to ensure easy compliance. In one case, the storage cabinet 10 should be heated to and maintain an internal temperature of at least about 145 degrees Fahrenheit.

In the illustrated embodiment, a thermometer/temperature sensor 30 is operatively coupled to the thermostat 28 and positioned in the lower half of the inner cavity 12. More particularly, the temperature sensor 30 may be located within 10%, or within 20%, or in another case, within 40% of the top edge of the trays 20/food product 22 in the vertical direction relative to the vertical height of the storage cavity 12, or within about six inches of the top edge of the tray 20/food product 22 in the vertical direction. This placement of the temperature sensor 30 ensures that the temperature sensor 30 is positioned relatively close to the food product 22 to ensure the food product 22 is maintained at the desired temperature. If the temperature sensor 30 were to be positioned too high in the inner cavity 12, the temperature sensor 30 would provide an inaccurate reading with respect to the temperature of the food product 22 due to higher temperatures present in the upper portions of the inner cavity 12.

In some cases the storage cabinet 10 may lack a thermostat/controller 28, and may instead include a simple manually operated controller (i.e. a knob or the like) that directly controls the output of the heat source 26. In this case a temperature sensor 30, such as a thermometer, may be positioned in the inner cavity 12 in the manner outlined above so that a user can track the temperature in the inner cavity 12.

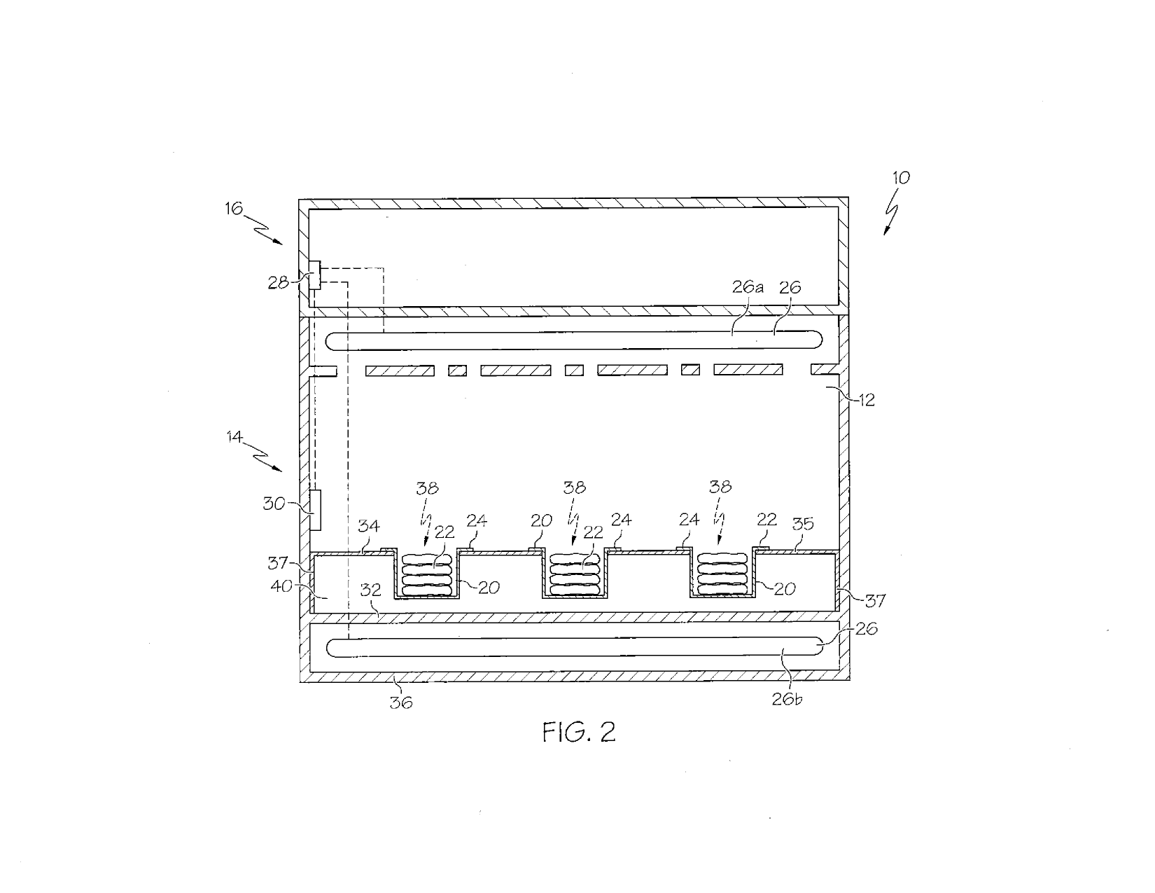

As best shown in FIG. 2, the storage cabinet 10 may include a generally horizontally-oriented bottom surface 32 and a generally horizontally-oriented base 36, oriented generally parallel with the support surface 34 and with the lower heating element 26b positioned therebetween. A support surface 34 rests on top of the bottom surface 32 and includes an upper generally horizontal portion 35 and a generally vertically extending outer lip 37. The support surface 34 may be removably positioned in the storage cabinet 10 such that the support surface 34 can be removed for cleaning and to enable further cleaning of the storage cabinet 10. The upper horizontal portion 35 of the support surface 34 may be generally continuous, but include a set of openings 38 formed therein, each opening 38 being shaped to closely receive the body of one of the trays 20 therethrough. In this manner, each tray 20 can be inserted into an opening 38 of the support surface 34 such that each tray 20 is suspended from the support surface 34 by its lip 24.

The majority of each tray 20 (i.e. in the vertical direction, or by surface area) may be positioned below the support surface 34. In this manner, when the trays 20 are received in the openings 38 of the support surface 34, the support surface 34 and trays 20 cooperate to form a generally closed volume 40 within/below the support surface 34, which is heated by the heat source 26b. The closed volume 40 traps heat therein, particularly heat provided by the lower heating element 26b, to ensure the food product 22 stored in the trays 20 are sufficiently heated. In particular, in this case five of the six sides of each tray 20 are exposed to the heat in the closed volume 40. Each tray 20 may be configured such that the bottom of trays 20 are elevated above the bottom surface 32. The horizontal spacing between the trays 20, and the vertical spacing between the trays 20 and the bottom surface 32, ensures that warm air can flow and circulate between the trays 20 and throughout the closed volume 40 for more even heating.

The front of the cabinet 10, in particular the lower portion 14, may have a relatively high height to provide good visibility to potential customers of the food product 22 stored in the inner cavity 12. In particular, the storage cabinet 10 may be configured such that the top of the lower portion 14 is positioned at least about twelve inches, in one embodiment, or at least about eighteen inches above the upper-most edge of the trays 20. Thus the cabinet 10 may provide at least about twelve inches or at least about eighteen inches of free space above the food product 22/trays 20/support surface 34 in the inner cavity 12. The additional height/space also helps customers to reach in and remove food product 22 without contacting the top/ceiling of the inner cavity 12.

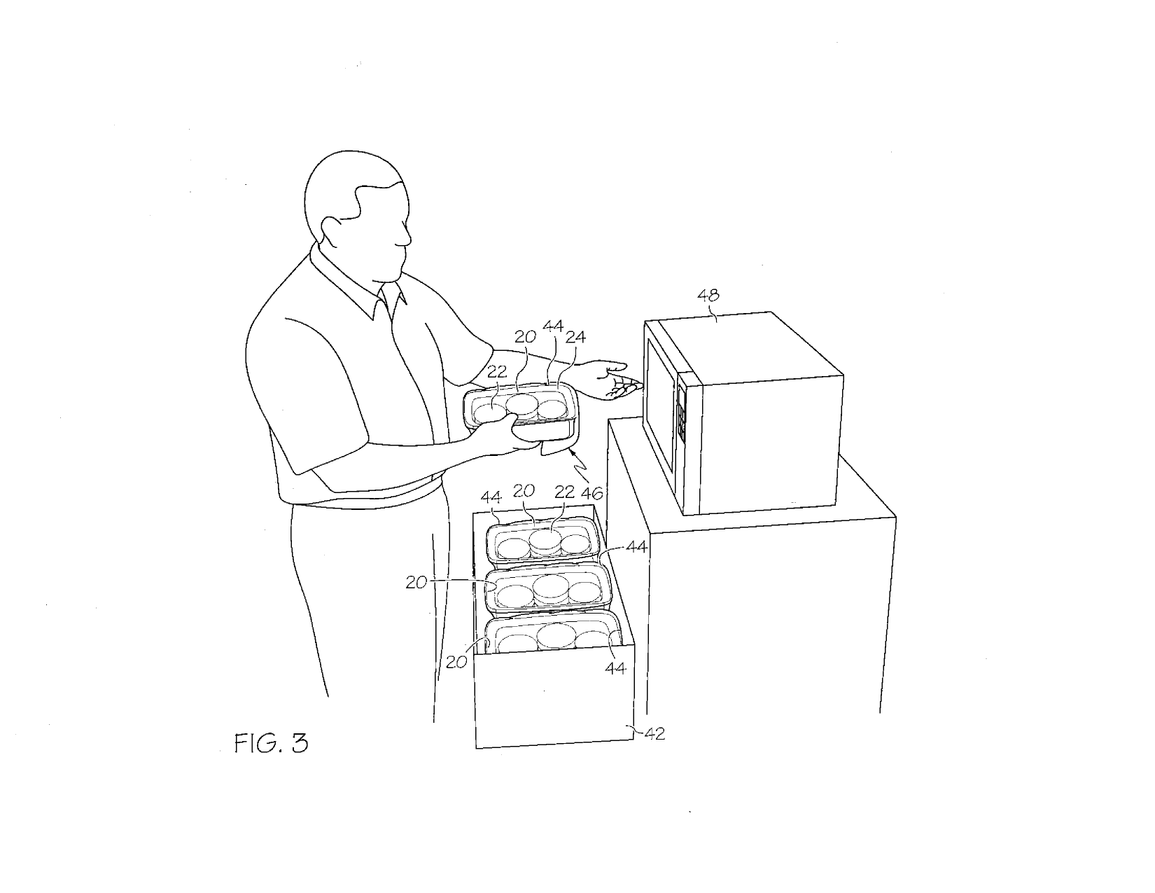

The food products 22, when made of protein, can be a blend of lean and fat meat materials, blended to a desired fat percent target. Any non-meat ingredients can then be blended into the meat mix. The food product 22 can then be formed into the desired shape (i.e. patties or other shapes) and fully or partially cooked. The food product 22 is then chilled to the appropriate temperature standards, placed in a tray 20, and covered with a covering material 44, as will be described below. A number of trays 20 may then be stored in packages or boxes 42 (FIG. 3), and shipped to a retailer.

In order to utilize the trays 20/storage cabinet 10, as shown in FIG. 3, an operator of the storage cabinet 10/retail operation, may receive packages 42 of pre-packaged food product 22. Each received package 42 should be stored in a refrigerator or freezer until use. The packages 42 may store a plurality of trays 20 therein, with the trays 20 storing fully cooked, or partially cooked (pre-cooked) food product 22 therein.

Each tray 20 may be entirely covered by a covering material, such as a sleeve or bag 44, which can entirely cover and encapsulate the tray 20 and food product 22, and may be sealed/closed at its open end 46 (e.g., in one case, by folding the open end 46 of the bag 44 under the tray 20, and optionally attaching the folded end 46 to the body of the bag 44). In some cases the bag 44 may be folded under the tray 20 such that the weight of the tray 20 substantially seals/closes the bag 44, and the bag 44 is not otherwise sealed/closed. In other cases the bag 44 can be closed/sealed by a twist-tie, heat sealing, adhesive, etc. In yet other cases the bag 44 is not sealed/closed at its open end. The bag 44 isolates the food product 22 from foreign objects, protects from freezer burn, and provides ease of handling throughout the storage, distribution, and heating stages. The bag 44 can also protect the food product 22 from extreme temperatures during distribution/storage.

The tray 20 and bag 44 can be made of any of a wide variety of materials, including polymers, such as polyethylene terephthalate (“PET”), and more particularly crystalline PET (“CPET”), for the tray 20 and biaxially-oriented polyethylene terephthalate, such as MYLAR® polyester film for the bag 44. The bag 44 and/or tray 20 can be generally clear or transparent to enable a user to view the food product stored therein. In one case the tray 20 and/or bag 44 are entirely made of polymer materials and lack any metals to aid in microwave compatibility. The tray 20 may be made of a relatively stiff material such that the tray 20 retains its shape, whereas the bag 44 may be made of a relatively thin/flexible material such that the bag 44 is easily manually shaped and manipulated.

In order to prepare the food product 22 for use in the storage cabinet 10, a user/operator removes each wrapped tray 20 from the package 42 and places the wrapped tray 20 into an oven 48, such as a microwave oven, as shown in FIG. 3. Both of the tray 20 and the bag 44 may be dual-ovenable; that is, safe for use in microwaves, conventional and/or convection ovens or other ovens such that the tray 20 and bag 46 can withstand elevated temperatures. For example, in one case the tray 20 and bag 44 may be able to withstand elevated temperatures (up to 350° F. for 30 minutes) and/or concentrated microwaves (such as those provided by a typical 1000 Watt microwave operating at full power for 5 minutes). In one case the tray 20 and bag 44 may be able to withstand such temperatures and/or exposure to microwaves sufficient to heat the food product 22 to an internal temperature of about 150° F., without melting, igniting or loss of integrity of the tray 20 or bag 46.

The food product 22 may be heated in the oven 48 for a specified time period and/or until it reaches the desired temperature. In one case, for example, the food product 22, when at a refrigerated (non-frozen) temperature, may be heated at full power for about three minutes in a 1000 Watt microwave. The tray 20 is removed from the oven 48. The food product 22 may then reside in the tray 20 for a specified period of time (about two minutes, in one case) to allow for moisture to settle back into the food product 22 and allow temperatures to equalize throughout the food product 22. The bag 44 is removed from the tray 20, such as by sliding the bag 44 off or manually tearing the bag 44, and the bag 44 is discarded.

The bag 44 may help to trap moisture during and after heating of the food product 22, and can be substantially air/oxygen/moisture/water vapor impermeable, or alternately may have some air and/or moisture and/or water vapor permeability to allow air, moisture, or water vapor under sufficiently high pressure to escape from the bag 44 during heating. When the bag 44 is substantially impermeable to oxygen and water vapor, this can help to provide a better quality food product, although some oxygen and water vapor may be able to permeate the bag 44 at a microscopic level and not via convection. Since the bag 44 entirely covers and encapsulates the tray 20 and food product 22, the bag 44 provides ease of use compared to many existing systems. In particular, the bag 44 may be easily manually removed, as opposed to “peel-back” sheets used in some existing microwaveable trays. In addition, because the bag 44 is attached (if at all) only to itself, and not to the tray 20 in one case, the bag 44 is easily entirely removed and does not leave any residue, adhesive, or torn portions on the tray 20.

Once the bag 44 has been removed, the heated tray 20, containing the food product 22, is placed in the storage cabinet 10, as shown in FIG. 1. The trays 20 (or their bottom panels) and the support surface 34 may be arranged generally horizontally in the storage cabinet 10 to avoid pooling of any juices, water or the like in the trays 20. Since the storage cabinet 10 has room for a number of trays 20, trays 20 storing differing types of food products 22 can, if desired, be stored in the storage cabinet 10. For example, in one case, one of the trays 20 stores beef patties, another of the trays 20 stores chicken patties, and yet another of the trays 20 stores pork patties. Appropriate labels identifies the differing food product 22 to the customer may be provided. Of course, various other types of patties can be placed in the trays 20/storage cabinet 10 as desired.

After the trays 20 with heated food product 22 have been placed in the storage cabinet 10, the food product 22 is available for self-use by the customer. As shown in FIG. 1, in one case the storage cabinet 10 includes, or is placed on or adjacent to, a drawer 50 which stores buns therein 52.

In order to access and retrieve the food product 22, a user may open the doors 18 and utilize tongs 54 (which may be stored on the side of the storage cabinet 10) to remove the food product 22 from the inner cavity 12, and place the food product 22 on a bun 52, as shown in FIG. 1. The storage cabinet 10 may include, or placed adjacent to, a flat surface 56 for such sandwich preparation. The user can then add condiments and/or toppings while the sandwich is positioned on the surface 56, or at other locations.

Once sufficient time has passed after initial heating of the food product 22 (e.g. about four hours in one case, assuming the food product 22 is kept at the appropriate temperature after initial heating), any remaining food product 22 in the trays 20 should be removed and discarded and replaced with freshly-heated food product 22. The trays 20 may be disposable and therefore an entire tray 20 and any food product 22 therein can be discarded. Each tray 20 may include a “sell-by time” label positioned thereon. A user can write the time on which the product 22 has been heated and/or the time for which the product 22 should be sold/discarded. Such times may be written on the tray 20 immediately after heating. The storage cabinet 10 may include lights positioned near the top of the inner cavity 12 to enhance the visibility of the food product 22 stored therein.

As shown in FIG. 4, in some cases certain ones of the tray openings 38 may not receive a tray 20 therein. In this case a cover or covers 60 may be placed on the support surface 34 and cover the unused openings 38. The covers 60 help to prevent heat from escaping by convection from the cavity 40 and provides a flat surface upon which the trays 20 or other hot products 64 can be displayed, such as fully-cooked pre-wrapped food products, including sandwiches, burritos, corndogs, etc. The covers 60 can be made of a thermally-conductive material, such as metal, which enables products to be placed directly on the cover 60 and heated in the desired manner.

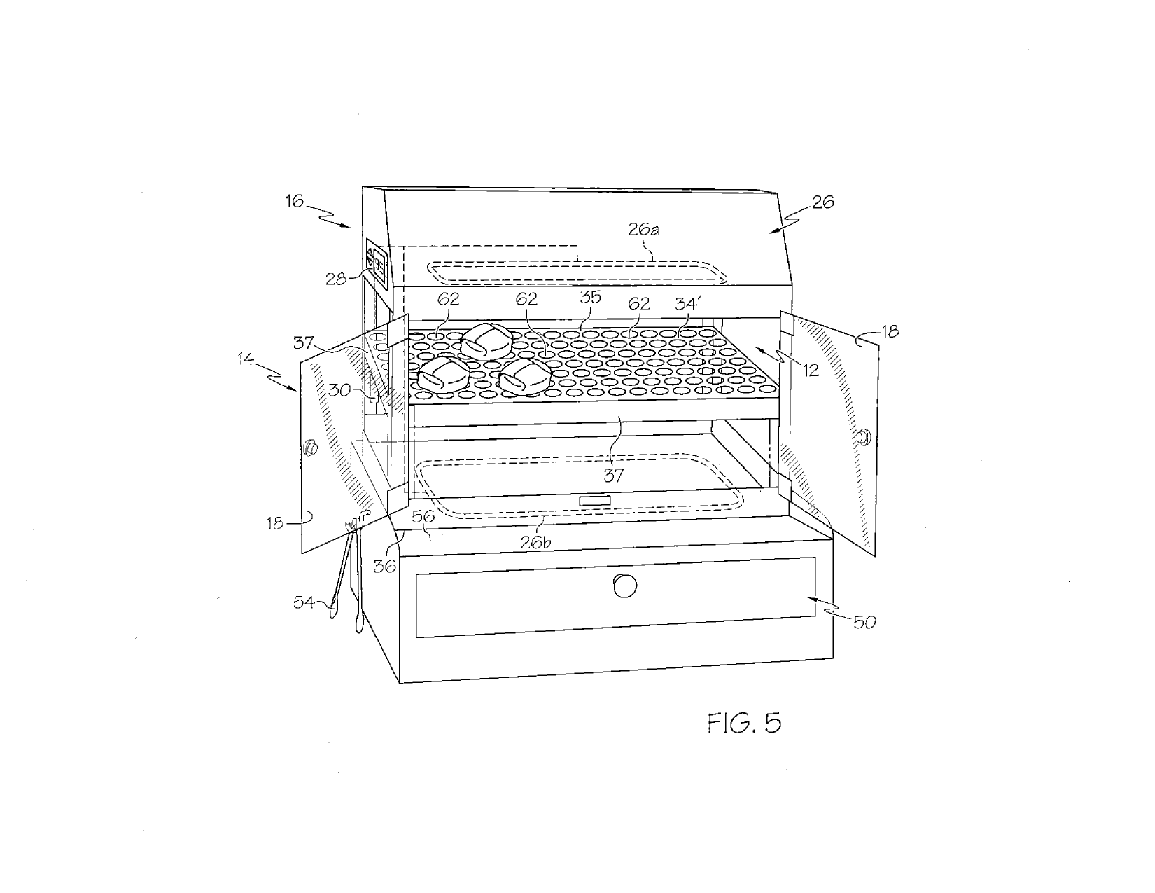

As shown in FIG. 5, if desired the support surface 34 can be removed, and an alternate support surface 34′ used in its place. In this case the support surface 34′ lacks the large openings 38, but may be made of a metal mesh-like or air-permeable material with a plurality of smaller openings 62 to allow some heat to escape from the cavity 40 by convection to heat food products 22 stored thereon. The upper horizontal portion 35 of the support surface 34′ thereby provides a flat surface upon which food products 22 and/or trays 20 can be placed or arranged in a variety of manners. The support surface 34′ can fill generally the entire footprint of the cavity 40 such that, in one case, the upper portion 35 of the support surface 34′ has a size and shape generally corresponding to bottom surface 32. The support surface 34′ shown in FIG. 5 is shown as a single integral unit, but if desired the support surface 34′ can be divided into two (or more) parts.

Thus, it can be seen that the system disclosed herein provides a convenient and easy-to-operate device which offers hot, fresh sandwiches in a self-serve format. By providing the cooked food product 22 in a pre-packaged format, the store staff can heat, handle and display the food product 22 in disposable trays 20 without handling the food product 22 itself. This system thereby eliminates the need for a food handling permit and the need for additional equipment such as wash sinks. The system operator and employees do not need to come into direct contact with the food product 22 or handle food product 22 other than indirectly handling the food product 22 via the trays 20. The trays 20 are not re-used and do not need to be washed or cleaned.

The storage cabinet 10 stores the food product 22 in a secure and temperature-controlled environment. The storage cabinet 10 displays the food product 22 in a format that is easily accessible so that the customers can access the food product 22 themselves and create their own sandwiches in their desired manner. Because the heating and storage of the food product 22 does not depend on rollers, the storage cabinet 10 can accommodate food products 22 of various shapes and formats, including traditional round hamburger patties, flat breaded or unbreaded chicken patties, pork ribs and patties, sausage patties or links, or even a loose products such as scrambled eggs, popcorn chicken, fried shrimp, etc.

Although the invention is shown and described with respect to certain embodiments, it should be understood that modifications will occur to those skilled in the art upon reading the specification, and the present invention includes all such modifications.

What is claimed is:

1. A food storage and dispensing device comprising:
a body having a generally closed inner cavity and a door configured to provide access to said inner cavity;
a support surface positioned in said inner cavity, said support surface having at least one opening; and
a heat source positioned below said support surface, wherein said opening is shaped to closely receive a tray therein to thereby trap heat below said support surface.

2. The device of claim 1 further comprising a tray closely removably received in said opening.

3. The device of claim 2 wherein said tray receives a food product therein.

4. The device of claim 2 wherein said body, said support surface and said tray together define a generally closed volume positioned below said support surface, and wherein the majority of a surface of said tray is positioned in said generally closed volume.

5. The device of claim 4 wherein said body includes a bottom surface positioned below said support surface and generally parallel thereto, wherein said heat source is positioned below said bottom surface, and wherein said bottom surface defines a lower surface of said closed volume.

6. The device of claim 2 wherein said tray is a generally rectangular prism, and wherein at least five sides of said tray are located generally below said support surface.

7. The device of claim 2 wherein said tray includes an outwardly-protruding lip extending around an upper perimeter thereof, and wherein said tray is positioned on said support such that said lip engages said support surface and said tray is suspended therefrom.

8. The device of claim 2 further comprising a supplemental heat source positioned above said support surface, wherein said tray is positioned vertically between said heat source and said supplemental heat source.

9. The device of claim 1 wherein said support surface has a plurality of supplemental openings positioned in said inner cavity, and wherein each supplemental opening is shaped to closely receive a tray therein to thereby trap heat from said heat source.

10. The device of claim 9 further comprising a plurality of trays, each tray being closely removably received in said at least one opening and in each of said plurality of supplemental openings.

11. The device of claim 1 further comprising a temperature sensor positioned in said inner cavity, wherein said temperature sensor is positioned within about six inches in the vertical direction of an upper surface of said support surface.

12. The device of claim 11 wherein said temperature sensor and said heat source are both operatively coupled to a controller configured to receive an output of said temperature sensor and to adjust an output of said heat source to ensure a temperature within said inner cavity remains above a predetermined temperature.

13. The device of claim 1 wherein said body is generally transparent to provide visibility to any food product stored therein.

14. The device of claim 1 wherein said support surface is removably positioned in said body.

15. The device of claim 1 further comprising a cover configured to be removably positioned on said support surface and cover said opening such that said cover provides a generally flat surface positioned above said opening that can support food products thereon, said cover being made of a thermally conductive material.

16. A food storage and dispensing device comprising:
a body having a generally closed inner cavity and a door configured to provide access to said inner cavity;
a support surface removably positioned in said inner cavity; and
a heat source positioned below said support surface.

17. The device of claim 16 wherein said support surface has at least one opening shaped to closely receive a tray therein to thereby trap heat from said heat source.

18. The device of claim 16 wherein said support surface is configured to directly receive food products thereon.

19. The device of claim 16 wherein said support surface is made of an air-permeable material.

20. The device of claim 16 wherein said body has a bottom surface and wherein said support surface has a size generally corresponding to said bottom surface.

21. A method for using a food storage and dispensing device comprising:
accessing a food storage and dispensing device including a body having a generally closed inner cavity and a door providing access to said inner cavity, a support surface positioned in said inner cavity, said support surface having at least one opening, and a heat source positioned below said support surface;
accessing a tray having a food product therein; and
placing said tray in said opening such that said tray is closely received therein to thereby trap heat below said support surface.
